(19) United States
(12) Patent Application Publication
(10) Pub. No.: US 2007/0102486 A1
(43) Pub. Date: May 10, 2007

(54) WIRE EMBEDDED BRIDGE

(75) Inventors: Andre Cote, Williamstown, NJ (US); Detlef Duschek, Sensbachtal (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: CHECKPOINT SYSTEMS, INC., Thorofare, NJ (US)

(21) Appl. No.: 11/551,995

(22) Filed: Oct. 23, 2006

Related U.S. Application Data
(60) Provisional application No. 60/729,623, filed on Oct. 24, 2005.

(51) Int. Cl. A47J 36/02

(52) U.S. Cl. 228/101

(57) ABSTRACT

A wire embedded bridge made by the apparatus and method disclosed by example herein may be commonly used for the formation of an RFID circuit or chip strap. The process uses flexible polyester and/or other films as a base component of the bridge. A wire is heated and embedded into the poly sheet at precise locations in a continuous process, for example, with the poly continuously moving in a machine direction. The locations of the wire make chip placement onto the wire track reliable and inexpensive, preferably using heat and pressure to bond the chips with the embedded wire and form a protected RFID circuit.

### CROSS-REFERENCE TO RELATED APPLICATIONS

This utility application claims the benefit under35 U.S.C. § 119(e) of Provisional Application Ser. No. 60/729,623 filed on Oct. 24, 2005 entitled WIRE EMBEDDED BRIDGE and whose entire disclosure is incorporated by reference herein.

### BACKGROUND OF THE INVENTION

1. Field of Invention

This invention is related to security tags, and in particular, to the manufacture of conductive straps often used, for example, for the integration of RFID circuits.

2. Description of Related Art

Chip bonding is costly. The two largest components of the cost of RFID tags today are the integrated circuit and the attachment of that circuit (otherwise known as silicon) to an antenna structure. While the increasing volume of the number of chips helps to drive the IC cost down, bonding is a mechanical process and does not benefit from the same technology advances or economic scale.

Current methods of chip bonding do not adequately address costs. A two-step approach of an intermediary chip strap achieves incremental costs improvement by relocating the costs. However, straps do not address the problem directly, as bonding is still required, but to a smaller tag. Moreover, straps add another step to bond the strap to the antenna structure. Current manufacturers, using standard bonding technology with straps, want straps to be like traditional bonding surfaces, as commonly found on circuit board technology that is, hard and inflexible. However, such straps do not lend themselves to easy integration into flexible tags (e.g., RFID tags). The standard bonding processes are all known strap-based solutions, and therefore less than ideal.

One related art attachment method, called Fluidic Self Assembly (FSA), provides insufficiently robust bonds. Because the chips find their own way into bonding sockets, the chips cannot use adhesives or flux, since anything sticky prevents free motion of the chips into the sockets. With the fluid self assembly process, the bond is made at a tangent between the chip bonding pad and sides of the bonding cavity. This flat-to-edge bond is different than and less reliable than traditional bonds, which are made flat-to-flat. Fluidic self assembly also places restrictions on the type of substrate that can be used. Fluidic Self Assembly (FSA) does not create the bond, it only places tags into appropriate carrier for attachment. Current FSA method being practiced uses patterned cut out polyester and laminates another film on top of the web with chips in place. The back web then is laser cut leaving a hole in direct proximity and above the chip bonding pad area. This hole is filled with conductive ink and a trace is completed on the back side perpendicular to the hole creating a strap. The FSA process is slow and uses multiple steps and requires a high degree of accuracy with known technology products available today.

A known wire bonding process is disclosed in U.S. Pat. No. 5,708,419 to Isaacson, et al., the contents of which are incorporated by reference herein in its entirety. Isaacson discusses the bonding of an IC to a flexible or non-rigid substrate which generally can not be subjected to high temperatures, such as the temperature required for performing soldering processes. In this wire bonding process, a chip or dye is attached to a substrate or carrier with conductive wires. The chip is attached to the substrate with the chip front-side face up. Conductive wires are bonded first to the chip, then looped and bound to the substrate. The steps of a typical wire bonding process include:
1. advancing web to the next bond site;
2. stopping;
3. taking a digital photograph of the bond site;
4. computing bond location;
5. picking up a chip;
6. moving the chip to the bond site;
7. using photo feedback to adjust placement to the actual site location;
8. placing or depositing chip;
9. photographing the chip to locate the bond pads;
10. moving the head to the chip bond pad;
11. pressing down, vibrating and welding conductive wire to the bond pad;
12. pulling up and moving the chip to the substrate bond pad, trailing wire back to the chip bond
13. pressing down and welding that bond;
14. pulling up and cutting off the wire; and
15. repeating steps 10-14 for each connection.

In contrast, the interconnection between the chip and substrate in flip-chip packaging is made through conductive connection pads or bumps of solder that are placed directly on the chip's surface. The bumped chip is then flipped over and placed face down, with the bumps electrically connecting to the substrate.

Flip chip bonding, a current state of the art process, is expensive because of the need to match each chip to a tiny, precision-cut bonding site. As chips get smaller, it becomes even harder to precisely cut and prepare the bonding site. However, the flip-chip bonding process is a considerable advancement over wire bonding. The steps of a typical flip-chip bonding process include:
1. advancing web to the next bond site;
2. stopping;
3. photographing the bond site;
4. computing the bond location;
5. picking up the chip;
6. moving the chip to the bond site;
7. using photo feedback to adjust placement at the actual site location;
8. placing the chip;
9. ultrasonically vibrating the placement head to weld chip in place; and
10. retracting the placement head.

Steps 1 through 8 of each of the above bonding processes are substantially the same. The web must stop to locate the conductive gap in the substrate and precisely place the IC. The related art processes require that the web is stopped and measured (e.g., photographing the bond site, containing the bond location, using photo feedback to adjust placement at the actual site location) so that the chip can be accurately placed as desired adjacent the gap and bonded.

Retracing a path during the bonding process takes time, causes vibration, and wears mechanical linkages. These linkages also create uncertainty in absolute position. Rotating or continuous devices are preferred over reciprocating devices, in part because stopping and starting the manufacturing line always slows things down and reduces throughput. It would be beneficial to adjust tooling to operate in a process that is continuously advancing down the line at a known rate of travel.

When chips are placed down on an antenna structure, such as an aluminum strap to form a bridge, nearby and overlapping conductive materials can create unwanted capacitance, especially at UHF or higher frequencies. Accordingly, it would be beneficial to minimize the conductive overlap to the bonding sites between the chips and the straps, especially for higher frequency use as the greater the overlap, the greater the unwanted capacitance and the lower the frequency of the tuning. All references cited herein are incorporated herein by reference in their entireties.

### BRIEF SUMMARY OF THE INVENTION

The preferred embodiments include a wire embedded strap and manufacturing approach for the creation of the strap that may be used, for example, in the formation of an RFID circuit, or for the formation of a simple dipole antenna for an RFID circuit. The preferred approach uses a flexible poly-based film as a base component of the strap. A wire is embedded into the poly at precise locations using heat and alignment aides. The embedded location of the wire allows for accurate chip placement onto the track that is reliable and inexpensive.

According to one of the preferred embodiments, the invention includes a manufacturing device for making a wire embedded strap. The manufacturing device includes a first rotary station, a heating station and a splitting station. The first rotary station continuously moves a sheet of poly (e.g., polyester, polyurethane, polystyrene, polypropylene, polyethylene, polyacrylate, copolymers, tripolymers and films thereof, etc.) along a machine direction. The heating station is adjacent to the first rotary station and heats a conductive strip as it continuously moves toward the first rotary station. The first rotary station embeds the heated conductive strip into the poly sheet as the conductive strip and poly sheet move about the first rotary station to form an embedded conductive strip. The splitting station separates the embedded conductive strip into portions of the conductive strip to form non-conductive gaps between consecutive portions of the conductive strip. Respective consecutive portions of the conductive strip are conductively communicatable with a respective circuit bridging the respective non-conductive gap between the respective consecutive portions and can form an antenna for the circuit. The preferred manufacturing device may also include an alignment unit adjacent the first rotary station that aligns the conductive strip with the poly sheet before the conductive strip is embedded into the poly sheet. In addition, the preferred manufacturing device may include a chip attach station that places circuits over the non-conductive gaps formed by the splitting station. The chip attach station may also bond the placed circuits to the respective portions of the conductive strip to form a bridge (e.g., by using a thermal compression process). The conductive strip may include one or more lines of wire.

Another preferred embodiment of the invention includes a method for making a wire embedded strap. The method includes continuously moving a poly sheet along a machine direction, heating a conductive strip continuously moving toward the poly sheet, embedding the heated conductive strip into the poly sheet as the conductive strip and the poly sheet continuously move to form an embedded conductive strip, separation the embedded conductive strip into portions of the conductive strip, and forming non-conductive gaps between consecutive portions of the conductive strip. Further, the preferred method may include aligning the heated conducted strip with the poly sheet before embedding the heated conductive strip into the poly sheet. The preferred method may also include placing respective circuits over the non-conductive gaps, and bonding the respective circuits to the consecutive portions adjacent the non-conductive gaps to form a bridge.

In accordance with yet another preferred embodiment, the invention includes a wire embedded strap having a poly sheet and a pair of conductive wires. The poly sheet (e.g., polystyrene, polyethylene, polyester) is adapted to continuously move along a machine direction of a rotary manufacturing device. The pair of conductive wires is embedded in the poly sheet substantially in parallel along the machine direction, with each of the pair of conductive wires separated along the machine direction into portions of the pair of conductive wires. Consecutive portions of the pair of conductive wires are longitudinally distanced along the machine direction by a non-conductive gap and conductively communicatable with a respective circuit bridging the non-conductive gap. The preferred wire embedded strap may also include the respective circuit conductively coupled to respective consecutive portions of the pair of conductive wires and conductively bridging the non-conductive gap between the respective consecutive portions.

### BRIEF DESCRIPTION OF SEVERAL VIEWS OF THE DRAWINGS

The invention will be described in conjunction with the following drawings in which like reference numerals designate like elements, and wherein:

FIG. 1 is a sectional side view of an in-mold chip attach manufacturing device in accordance with the preferred embodiments of the invention;

FIG. 2 is a top view of an embedded wire and chip attach approach in accordance with the preferred embodiments;

FIG. 2A is a perspective view of a chip strap (poly sheet omitted) made in accordance with the approach of FIG. 2;

FIG. 3 is an exploded side view partially in section of a chip strap in accordance with the preferred embodiments;

FIG. 4 is a sectional view of the chip strap shown in FIG. 3;

FIG. 5 is a side sectional view illustrating a first preferred approach for creating a non-conductive gap at a first time;

FIG. 6 is a side sectional view illustrating the first preferred approach for creating a non-conductive gap at a second time;

FIG. 7 is a side sectional view illustrating a second preferred approach for creating a non-conductive gap;

FIG. 8 is a side view partially in section illustrating a third preferred approach for creating a non-conductive gap at a first time; and

FIG. 9 is a side sectional view illustrating the third preferred approach for creating a non-conductive gap at a second time.

DETAILED DESCRIPTION OF PREFERRED EMBODIMENTS OF THE INVENTION

According to the preferred embodiments of the invention, a heated wire (e.g., aluminum, gold, silver, copper, and/or combinations thereof) is embedded into a poly (e.g., polystyrene, polyethylene, polyester, polypropylene, polyethylene, polyacrylate, copolymers, tripolymers and films thereof) at precise locations for alignment with subsequently placed chips and for conductive communication with the wire. The wire has dimensional stability and is preferably in the area of 2 mils in diameter, or commonly known as 40 to 50 American Wire Gauge (AWG). In a preferred embodiment, two independent lines of wire are embedded into the poly and transversely spaced to align with connection points (e.g., conductive contact bumps) of a subsequently placed chip. The embedded wire is cut and longitudinally separated to form gaps that are non-conductive between the separated wires. The non-conductive gaps in the wire are formed preferably to use as an antenna for a coupled chip and/or to prevent an electrical short that may otherwise occur if the chip (e.g., RFID chip, transponder) is placed adjacent the gap and in conductive communication with separated portions of the embedded wire.

An exemplary preferred embodiment for a wire embedded strap and approach for making a wire embedded strap is shown in FIGS. 1-4. As can best be seen in FIG. 1, a manufacturing device 10 for making a wire embedded strap includes a rotary station 12 having two rollers 14 and 16 that continuously move a poly sheet 18 along a machine direction 20. The manufacturing device 10 also includes a heating station 22 that heats the conductive strip (e.g., wire 24, rod, coil) to a temperature that softens the poly sheet 18 and allows the roller 14 to embed the conductive strip into the malleable poly sheet 18 by pushing the conductive strip into the poly sheet. In particular, the heated wire 24 deforms the poly sheet 18 at their intersection, which allows the roller 14 to push the wire into the poly sheet, thereby embedding the wire. Preferably, the manufacturing device 10 includes an alignment unit 26 that aligns the wire 24 in a predetermined position to help control its lateral or transverse placement in the poly sheet 18. While not being limited to a particular theory, the manufacturing device 10 also includes a splitting station 28 that longitudinally separates the wire along the machine direction into wire strips 30 with non-conductive gaps 32 between consecutive wire strips, as will be described in greater detail below. The non-conductive gaps 32 may subsequently be bridged by a chip to form a chip strap as will also be described in greater detail below.

Still referring to FIG. 1, the poly sheet 18 moves in a machine direction along the manufacturing device 10. While not being limited to a particular theory, the poly sheet 18 preferably continuously moves along the manufacturing device 10 with the aid of rollers such as the roller 16 and the roller 14 (also referred to as the embedding roller 14). The rollers are preferably formed of a hard rubber or metal capable of gripping the poly sheet to continuously advance the sheet. The embedding roller 14 is preferably made of a material or composition that is hard enough to push the wire 24 into the poly sheet 18 and is temperature resistant so as to not deform or otherwise be adversely affected by the temperature of the heated wire. Therefore, the shapes of the embedding roller 14 and the roller 16 are not compromised by the temperature of the heated wire 24, which is high enough to melt or soften the poly sheet 18 and allow its deformation to accept the wire. The poly sheet 18 becomes a protective carrier for the wire 24, and thus prevents unwanted damage to the wire after it is embedded into the poly sheet.

The heating station 22 and alignment unit 26 prepare the wire for accurate and consistent placement in the poly sheet 18. The heating station 22 heats the wire 24 as readily understood by a skilled artisan, for example by applying heat, radiation, or other energy to the wire and causing the temperature of the wire to increase to a temperature sufficient to melt or soften the poly sheet 18 and allow the poly sheet to accept the wire as the wire is pushed into the poly sheet by the embedding roller 14. The alignment unit 26 includes grooves (e.g., spacers, openings 27) that allow the wire 24 to pass through the alignment unit at the grooves or openings so that the wire 24 is aligned as desired to be embedded into the poly sheet at a precise location. Preferably, the aligned location of the wire 24 is set corresponding with connection pads 40 (e.g., contact points, conductive bumps) of circuits that may be attached to the wire at a subsequent time. While not being limited to a particular theory, the alignment unit 26 is preferably located between the heating station 22 and the embedding roller 14 and as close to the embedding roller as needed to prevent the wire 26 from wandering off of its aligned position before being embedded into the poly sheet 18. However, it is understood that the location of the alignment unit 26 is not limited thereto, as the alignment unit may be attached to the heating station 22 or may be part of the rotary station 12, as long as the alignment unit 26 provides for the alignment of the wire that is embedded into the poly sheet 18.

Still referring to FIG. 1, the wire 24 is shown as a wound conductive strip that unwinds to dispose the wire toward the poly sheet 18. It is understood that the manner of the wires origin is not critical to the invention, as the spool of wire is simply an example of where the wire 24 preferably comes from. Accordingly, the wire 24 may arrive at the heating station 22 in other manners, as would readily be understood by a skilled artisan.

After the wire 24 is embedded into the poly sheet 18, the wire is cut into wire strips 30. In particular, a splitting station 28 cuts the embedded wire 24 as it moves with the poly sheet 18 at intervals determined to provide wire strips 30 of sufficient length for its intended use (e.g., antenna, connector, chip strap, bridge). Preferably, the splitting station 28 also separates the cut wire straps 30, leaving a gap in conductivity between consecutive wire straps. While not being limited to a particular theory, there are several approaches for forming the non-conductive gaps between the consecutive wire straps, with the preferred approaches described in greater detail below.

As is well known in the art, a chip or circuit having multiple conductive connection pads attached to a single conductive strip may become shorted if there is no conductive gap in the strip between the connection pads of the chip. Accordingly, in a preferred embodiment, non-conductive gaps 32 are formed between consecutive wire strips 30. The gaps are large enough to prevent direct conductive communication between the consecutive wire strips 30, yet small enough to allow attachment of a chip or circuit to the consecutive wire strips over the gaps, for example, as shown in FIGS. 1-3. The wire strips 30 can then be used as an antenna for the chip.

In operation, the rollers 14 and 16 continuously urge and move the poly sheet 18 along the machine direction 20. The wire 24 preferably moves continuously from its spooled starting location 34 toward the poly sheet 18 and, after it is embedded, along the machine direction 20 with the poly sheet 18. The heater 22 heats the wire 24 to a temperature that melts or softens the poly sheet 18 that contacts the heated wire. As one skilled in the art would readily understand, preferred temperatures for the heated wire can be determined at least in part by the poly sheet material, the size of the wire, and the speed of the poly sheet 18 through the rollers 14, 16. The speed is limited only in the ability to maintain tension in the webs and control product formation. In the where chips are not to be attached in line to the wire 24, one could assume a running web speed of about 300 to 400 feet per minute. This rate will not likely be achieved when attaching chips in line as described in greater detail below, yet the speed of the poly sheet 18 through the rollers is still several times faster than the current technology. The current output standard that most manufacturers are trying to achieve is about 20,000 units (e.g., chip straps) per hour. This equates to a web speed rate of 2 to 3 feet per minute for a 0.040 inch chip under the current technology.

The wire 24 is configured to be embedded at a precise transverse location of the poly sheet 18 by the alignment unit 26. As the heated and aligned wire 24 reaches the embedding roller 14, the heated wire is pushed through a first side 78 of the poly sheet 18 by the roller 14. The roller 16 is located at a second side 76 of the poly sheet 18 opposite the embedding roller 14 to support the poly sheet against the wire being pushed into the poly sheet by the embedding roller. The embedding roller 14 pushes the wire 24 into the softened poly sheet 18, preferably to a depth where an exposed portion of the embedded wire is substantially coplanar with the first side 78 of the poly sheet. An example of the preferred depth of the embedded wire 24 into the poly sheet is shown at FIG. 4, which is discussed in greater detail below.

After the heated wire 24 is embedded into the poly sheet 18, the wire and poly sheet continue along the machine direction 20 in a continuous motion. The continuously moving poly sheet 18 and embedded wire 24 advance through the splitting station 28, which separates the wire into wire strips 30. Then, for chip attach, the poly sheet 18 and wire strips 30 continue through a chip attach station 36, which attaches a chip 38 to consecutive wire strips 30 to form a conductive bridge over a respective non-conductive gap 32. The chips 38 are attached to the consecutive wire strips 30 in a known manner such as a flip chip process where the chips 38 have conductive connection pads 40 (e.g., contact points, conductive bumps) placed on the wire strips, and the placed chip 38 is compressed and heated to bond the connection pads 40 to the embedded wire 24 and create a chip strap 42 as shown for example in FIGS. 1-4.

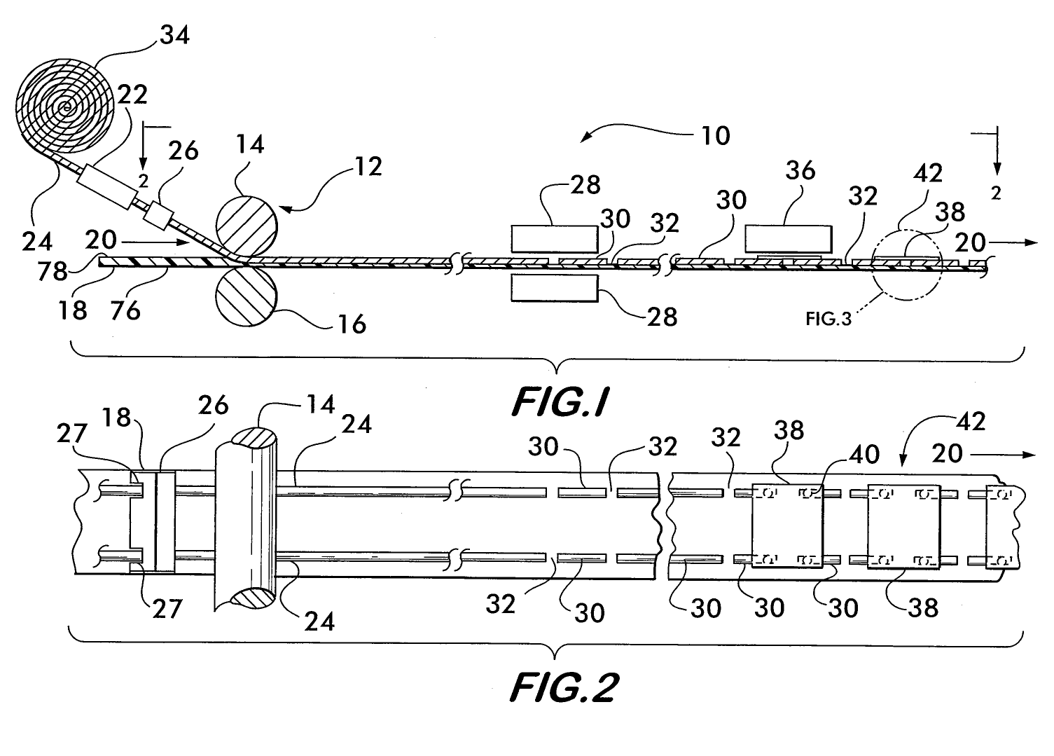

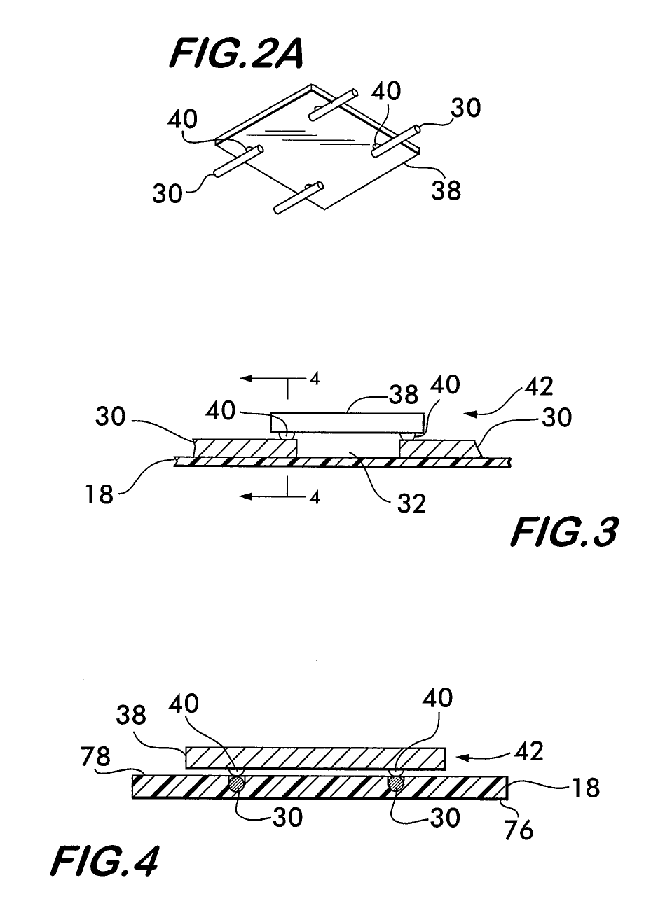

FIG. 2 is a partial top view of the poly sheet 18, wire 24, embedding roller 14 and chips 38 of the preferred embodiment shown in FIG. 1. While not being limited to a particular theory, the exemplary embodiment shown in FIG. 2 illustrates two lines of wire 24 distanced from each other and embedded side by side into the poly sheet 18. The two lines of wire 24 are simultaneously embedded substantially in parallel by the embedding roller 14 into the poly sheet 18 as the poly sheet moves continuously in the machine direction 20. As can be seen in FIGS. 1 and 2, after the lines of heated wire 24 are embedded by the embedding roller 14, both lines of wire 24 are cut by the splitting station 28, which forms gaps 32 between consecutive wire strips in each line. The chip attach station 36 then places chips 38 over the gaps 32 for conductive communication with the wire strips 30 via the connection pads 40 that are attached to the wire strips.

It should be noted that the size of the chips 38 and the number of connection pads 40 of the chips are not critical to the invention, and are merely shown as an example of the preferred embodiment. It is understood that the size of the chips 38 and the number or placement of the connection pads 40 are configured to allow the connection pads to align with the conductive strip or strips of wire 24 over a corresponding gap between the wire strips 30 that are attached to the connection pads of the chip 38. For example, a chip 38 having two connection pads 40 could be attached to consecutive wire strips 30 from a single line of wire 24. Moreover, a chip 38 having four connection pads 40 may preferably be attached to consecutive wire strips 30 separated and originating from two lines of wire 24, as shown in FIG. 2. In other words, the number of lines of wire embedded into the poly sheet 18 should correspond with the number and configuration of connection pads on the chips 38 that are to be attached to the wire 24, as would readily be understood by a skilled artisan. In addition, the wire preferably does not surpass the connection pad on the chip.

The chip attached station 36 (FIG. 1) places the chips 38 or circuits onto wire strips 30 separated by non-conductive gaps 32 to form chip straps 42 having a wire embedded bridge. The wire embedded bridge of the preferred embodiments includes consecutive wire strips 30 embedded and formed in the poly sheet 18 in a continuous process. The wire embedded bridge is configured to attach to a chip 38 or circuit to form a chip strap with its wires embedded into the poly sheet for protection. The wire embedded bridge may also form a dipole antenna that may be used with the chips 38.

Preferably the chips 38 are also pressed firmly into the poly sheet 18 to backfill the underside of the chip to add stability to the strap and chip as it is allowed to flex in downstream processes and during ultimate product use. Examples of chip straps and/or wire embedded bridges are shown in FIGS. 2A-4 in accordance with the preferred embodiment. For example, FIG. 3 is an exploded side view partially in section of an exemplary chip strap 42 shown in FIG. 1. In FIG. 3 the poly sheet 18 encapsulates the wire 30 and therefore the wire is at a similar level in the plain as the poly sheet. There is preferably no gap in the poly sheet 18, since it is not melted away or cut away; preferably only the wire is cut.

As can be seen in FIG. 3, the chip 38 is placed over a gap 32 between consecutive wire strips 30 such that the chips' connection pads 40 are in conductive contact with the wire strips. In this manner, the chip 38 bridges that gap 32, and is conductively coupled to the wire strips 30. FIG. 4 is a side sectional view of the chip strap 42 shown in FIG. 3. As such, FIG. 4 shows the wire strips 30 embedded in the poly sheet 18 and coupled to the connection pads 40 of the chip 38. To help secure the attachment of the chip 38 to the embedded wire strips 30, the chip can be bonded to the wire preferably using compression and heat as is well known in the flip chip bonding technology. Such a process provides both a conductive and mechanical bond for enhanced security and reliability.

FIG. 2A is a perspective view of a chip strap (with the poly sheet 18 omitted) as provided by the manufacturing device 10 and process described in conjunction with FIGS. 1, 2, 3 and 4. As can best be seen in FIGS. 2 and 2A, the wire strips are transversely separated by the alignment unit 26 to a distance predetermined for alignment with the connection pads 40 of the chips 38. While not being limited to a particular theory, the connection pads 40 of the chips 38 (e.g., flip chip) are shown in FIGS. 2A-4 inwardly offset from the periphery of a chip. However, the connection pads 40 may be located at other locations of the chip (e.g., at the periphery, adjacent the periphery) and the alignment unit 26 would offset the strips of wire 24 to align with the locations of the connection pads, for example by increasing or decreasing the distance between the lines of wire.

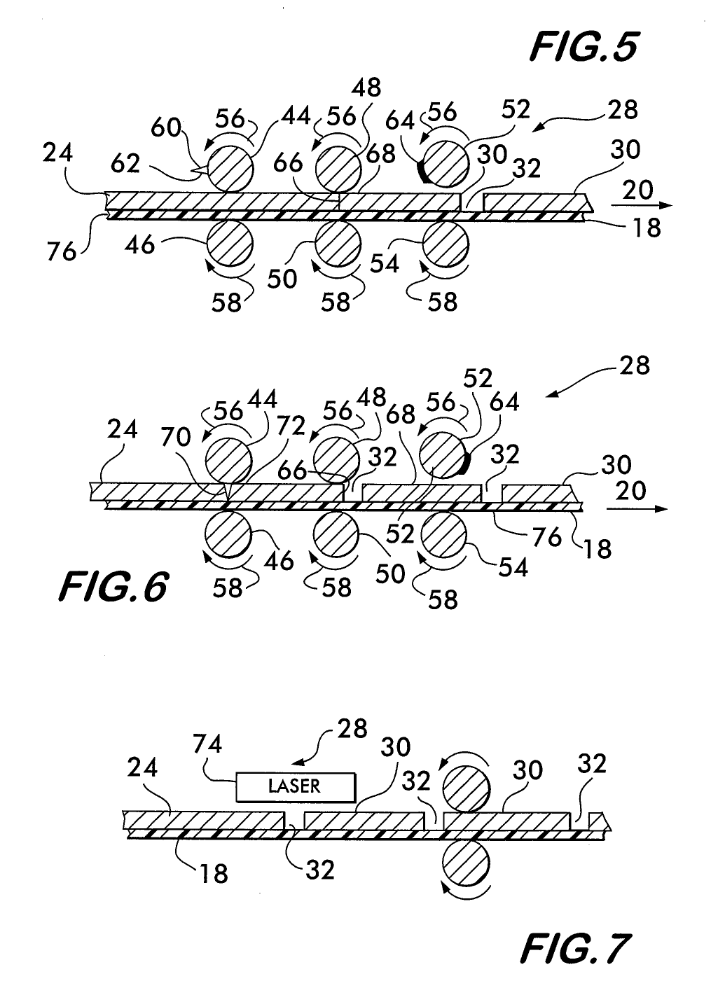

As noted above, the manufacturing device 10 includes a splitting station 28 that cuts the wire 24 into wire strips 30 and separates the wire strips with a non-conductive gap 32. The gap 32 is formed between consecutive wire strips 30 and the poly refills the gap as needed to prevent electrical problems, for example shorting of a chip coupled to the consecutive wire strips during use. The gaps 32 may be formed by numerous approaches and the invention is not limited to any one approach. Some exemplary approaches for creating the non-conductive gaps are described below in conjunction with FIGS. 5-9.

FIGS. 5 and 6 illustrate a first preferred approach for creating non-conductive gaps 32 between consecutive wire strips 30. In this embodiment, the splitting station 28 includes a cutting station having rollers 44 and 46, and a gap forming station having rollers 48, 50, 52 and 54. All of the rollers 44, 46, 48, 50, 52 and 54 are at least in partial contact with the embedded wires 24 and/or the poly sheet 18 and rotating such that the rollers help advance the embedded wire/poly sheet in the machine direction 20. For example, the view shown in FIGS. 5 and 6, the rollers 44, 48 and 52 rotate counter-clockwise as indicated by rotational arrow 56, and rollers 46, 50 and 54 rotate clockwise as indicated by rotational arrow 58. While not being limited to a particular theory, and unless otherwise noted below, the rollers are preferably formed of rubber, plastic or metal that permits the rollers to roll with and/or urge the embedded wire and poly sheet in the machine direction 20.

Still referring to FIGS. 5 and 6, roller 44 includes a mechanical cutter, for example a blade 60 that extends outwardly from the perimeter of the roller to a sharp edge 62. The blade 60 is adapted to rotate with the roller 44 and engage with and cut through the embedded wire 24 as the wire moves with the poly sheet 18 continuously along the machine direction 20. Preferably, the blade extends from the periphery of the roller 44 to a length that allows the blade to cut through the wire 24, but not through the poly sheet 18 surrounding the wire so that the integrity of the poly sheet is not compromised. The roller 46 is located on the side or surface 76 of the poly sheet 18 opposite the roller 44 and provides a support or backing for the poly sheet as the blade 60 cuts the wire 24. Accordingly, the roller 44 aided by the roller 46 cuts the embedded wire 24 into the wire strips 30.

As noted above, the gap forming station of the splitting station 28 includes the rollers 48, 50, 52 and 54. The rollers 48, 50 are located on opposite sides of the embedded wire/poly sheet, and are adapted to grip and advance the embedded wire and poly sheet continuously at a consistent speed. In particular, the roller 48 grips at least the embedded wire 24 and preferably the first side 78 of the poly sheet 18 adjacent the roller 48, and the roller 50 grips the second side 76 of the poly sheet adjacent the roller 50. The roller 54 is substantially similar to the rollers 46 and 50 in that the roller 54 remains in contact with and urges the second side 76 of the poly sheet adjacent the roller 54 at a consistent speed in the machine direction 20. However, the roller 52 rotates faster than roller 48 so that its surface moves faster than the belt speed of the poly sheet 18. In other words, rollers 48 and 50 are essential a mechanical nip point which drives the web (e.g., poly sheet 18) at a particular speed which matches that of the cutting roller 44. However, the roller 52 is a servo control roller that is overdriven and acts to stretch the web slightly at the location that the wire 24 was cut, by nipping the web and, due to higher speed, pulling the poly sheet 18 forward faster than the prior nip point of rollers 56 and 58.

The roller 52 includes a gripping member 64 radially extending outwardly from the periphery of the roller 52 preferably as a ridge extending longitudinally along the length of the roller. Preferably, the gripping member 64 is the only portion of the roller 52 that comes into contact with the first side 78 or surface of the poly sheet 18 and the embedded wire strips 30. In other words, in this preferred approach, the roller 52 grabs the wire strips 30 with the gripping member 64; otherwise, the roller 52 does not touch the wire or poly sheet. With the roller 52 spinning at a rate faster than the other rollers, and in particular, the roller 48, the gripping member 64 contacts and grips the first side 78 of the poly sheet 18 and the embedded wire strips 30, and tugs or urges the wire and first side 78 at a speed faster than the next wire strip 30 moving at the continuous speed of the rollers 48 and 50. The tugging by the gripping member 64 moves the wire strip 30 away from the next wire strip that is still in contact with the roller 48. The separation creates a non-conductive gap 32 between the wire strips 30 between the rollers 48 and 52. As this process continues, the gripping member 64 separates each cut wire strip 30 from the next wire strip by gripping and moving the respective wire strip at a pace faster than the pace of the next wire strip, creating a gap 32 between consecutive wire strips 30 embedded in the poly sheet 18.

FIG. 5 shows a cut 66 in the embedded wire 24 made by the blade 60. At this time, t₀, the wire strip 68 is not attached to the wire 24 as the cut 66 has separated the two. At a subsequent time, t₁, as exemplified in FIG. 6, the roller 44 continues its rotation, causing the blade 60 to cut through the embedded wire 24 and form a cut 70 and a wire strip 72. Still referring to FIG. 6, the roller 52 continues its rotation, causing the gripping member 64 to grab and pull wire strip 68 away from wire strip 72, creating a non-conductive gap 32 there between. This process continues to create non-conductive gaps between the consecutive wire strips 30 advancing in the machine direction 20.

It should be noted that all of the rollers described herein illustrates an example of a rotary station, as a whole or in part. That is, a rotary station may include at lest one of the rollers (e.g., the roller 44, the roller 48, the roller 52), a pair of the rollers oppositely arranged on the poly sheet 18 (e.g., the pair of rollers 44 and 46, the pair of rollers 48 and 50, the pair of rollers 52 and 54), or any equivalent elements as understood by a skilled artisan that affect the continuously moving poly sheet and/or wire 24 as described by example via the rollers herein.

A second preferred example of the splitting station 28 is exemplified in FIG. 7. In particular, the splitting station 28 illustrated in FIG. 7 includes a laser device 74 that periodically emits an intense monochromatic beam of light at the continuously moving wire 24 embedded in the poly sheet 18. This laser beam separates the wire to create non-conductive gaps 32 between consecutive wire strips 30. That is, the laser device 74 emits a laser beam that cuts through the wire 24 to form the wire strips 30, and that ablates the wire exposed to the laser to create the non-conductive gaps 32.

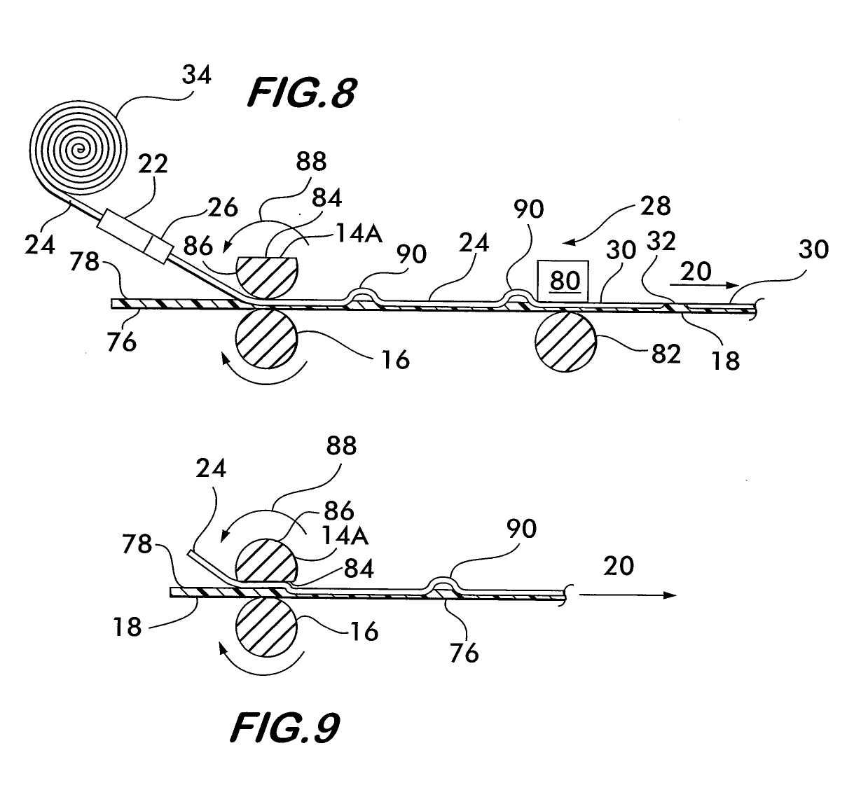

Yet another preferred example of the splitting system 28 is shown in FIGS. 8 and 9. In this approach, the splitting station 28 includes a cutting station 80 located adjacent the first side 78 of the poly sheet 18, and a support member, for example a roller 82 located at the second side 76 of the poly sheet opposite the cutting station 80. The cutting station 80 includes a blade, laser or cutting member adapted to cut the wire 24 extending above the first side 78 of the poly sheet 18 as described in greater detail below. FIG. 8 also illustrates the roller 16 shown in FIG. 1 and a roller 14A. The roller 14A is an alternative rolling member to the roller 14 shown in FIG. 1 and is somewhat similar to the roller 14 in its purpose and material. The roller 14A includes a curved portion 86 that embeds the wire 24, as described above for roller 14. However, the roller 14A also includes a flat portion 84 that does not extend radially to the periphery of the curved portion 86 of the roller 14A. In operation, as the roller 14A turns in the direction of the rotational arrow 88, the curved portion 86 embeds the heated wire 24 into the poly sheet 18 by pushing the wire into the poly sheet. However, the flat section does not push the wire into the poly sheet. Instead, as can best be seen in FIG. 9, the wire 24 remains above the poly sheet while the flat section 84 of the roller 14A faces the poly sheet 18. The wire 24 that is not embedded remains above the poly sheet 18 as exposed wire sections 90. As the roller 14A continues its rotation, the curved portion 86 again embeds the wire 24 adjacent the now downstream wire section 90 by pushing it into the poly sheet.

Referring to FIG. 8, the cutting station 80 cuts the exposed wire sections 90 above the first side 78 of the poly sheet 18 as the poly sheet advances in the machine direction 20 to create the non-conductive gaps 32 and the embedded wire strips 30. Alternately the exposed wire section 90 can be etched away from the embedded wire strips 30, with the wire that is completely embedded being protected from being etched. While not being limited to a particular theory, the cutting station 80 preferably includes a blade, laser, or other cutting member located adjacent the first side 78 of the poly sheet 18 to cut the exposed wire sections 90 as readily understood by a skilled artisan. The inventors have discovered that the edges of the wire strips 30 that have been cut by the cutting station 80 are preferably left turned upwards out of the poly sheet 18 for reliable attachment with the connection pads 40 of a subsequently placed chip 38.

While not being limited to a particular theory, the preferred embodiments of the invention provide wire strips at least partially embedded into a poly sheet in a continuous motion. The inventors have discovered that connecting the connection pads of chips to independent lines of wire, as shown for example in FIG. 2A, minimizes unwanted parasitic capacitance between the chip circuit and its antenna structure, especially over chips attached to single antenna bands. The parasitic capacitance becomes more relevant as the chip is used with higher frequencies (e.g., UHF or higher). When coupling a chip to an antenna structure, any nearby conductive material matters as it can create unwanted capacitance, lowering the frequency of the tuning. Accordingly, in the preferred embodiments, the wire does not surpass the respective connection pad on the chip. The chip strap 42 made by the manufacturing device and method described herein provides an additional benefit of minimizing parasitic capacitance by minimizing conductive overlap around the bonding sites between the chip and the antenna structure. In fact, the preferred diameter of the wire 24 is less than the diameter of the connection pads 40 of the chip 38 to further minimize conductive overlap.

While not being limited to a particular theory, the preferred depth of the poly sheet 18 is 50 to 75 microns and the preferred diameter of the wire 24 is 25 to 50 microns. However, it is understood that measurements of the poly sheet and wire are not critical to the invention as other measurements may be used and are considered within the scope of the invention. Preferably, the depth of the poly sheet 18 is greater than the diameter of the wire 24, which is preferably not insulated and formed of a conductive material (e.g., gold, aluminum, copper).

It is understood that the in-mold chip attach method and apparatus, and the wire embedded strap described and shown are exemplary indications of preferred embodiments of the invention, and are given by way of illustration only. In other words, the concept of the present invention may be readily applied to a variety of preferred embodiments, including those disclosed herein. While the invention has been described in detail and with reference to specific examples thereof, it will be apparent to one skilled in the art that various changes and modifications can be made therein without departing from the spirit and scope thereof. For example, the gripping member 64 shown in FIGS. 5 and 6 could be at least one extending bump, instead of a ridge, with each bump aligned with a line of wire 24 to move the wire strips 30 forward at a speed faster than the bolt speed of the poly sheet 18 and create the non-conductive gaps 32. Without further elaboration, the foregoing will so fully illustrate the invention that others may, by applying current or future knowledge, readily adapt the same for use under various conditions of service.

What is claimed is:

1. A manufacturing device for making a wire embedded strap, comprising:
a first rotary station continuously moving a poly sheet along a machine direction;
a heating station heating a conductive strip continuously moving toward said first rotary station, said first rotary station embedding the heated conductive strip into the poly sheet as the conductive strip and poly sheet continuously move along the machine direction to form an embedded conductive strip; and
a splitting station separating the conductive strip along the machine direction into portions of the conductive strip, said splitting station forming nonconductive gaps between consecutive portions of the conductive strip with respective consecutive portions conductively communicatable with a respective circuit bridging the respective nonconductive gap between the respective consecutive portions.

2. The manufacturing device of claim 1, further comprising an alignment unit adjacent said first rotary station, said alignment unit including grooves that align the heated conductive strip with the poly sheet.

3. The manufacturing device of claim 2, wherein said alignment unit is located between 2 0 said heating station and said first rotary station.

4. The manufacturing device of claim 2, wherein said heating station includes said alignment unit.

5. The manufacturing device of claim 2, wherein said first rotary station includes said alignment unit.

6. The manufacturing device of claim 1, further comprising a chip attach station that places respective circuits over the nonconductive gaps formed by said splitting station and bonds the respective circuits to the consecutive portions of the conductive strip.

7. The manufacturing device of claim 1, wherein said splitting station includes a laser that periodically ablates the conductive strip embedded in the poly sheet continuously moving along the machine direction to form the nonconductive gaps.

8. The manufacturing device of claim 1, wherein said splitting station includes a cutting station and a gap forming station, said cutting station cutting the conductive strip embedded in the poly sheet continuously moving along the machine direction into the portions of the conductive strip, said gap forming station separating consecutive portions of the conductive strip to form the nonconductive gaps.

9. The manufacturing device of claim 8, wherein said cutting station includes a second rotary station continuously moving the embedded conductive strip along the machine direction, said second rotary station including a blade that cuts the conductive strip.

10. The manufacturing device of claim 8, wherein said gap forming station includes a second rotary station and a third rotary station, said second rotary station gripping the embedded conductive strip continuously moving along the machine direction at a first speed, said third rotary station including a fast forwarding member that periodically urges the portions of the embedded conductive strip continuously moving along the machine direction at a second speed different than the first speed to form the nonconductive gap.

11. The manufacturing device of claim 1, wherein said first rotary station includes a first roller adjacent a first side of the continuously moving poly sheet that pushes the heated conductive strip into the poly sheet to embed the conductive strip, and a second roller adjacent a second side of the continuously moving poly sheet opposite the first side.

12. The manufacturing device of claim 11, wherein said first roller periodically pushes the heated conductive strip into the poly sheet to periodically embed the conductive strip, and said splitting station includes a cutter that cuts the conductive strip not embedded in the poly sheet to form the portions of the conductive strip and the nonconductive gaps.

13. The manufacturing device of claim 12, wherein said cutter includes a blade.

14. The manufacturing device of claim 1, wherein the embedded conductive strip is a pair of conductive wires embedded in said poly sheet substantially in parallel along the machine direction.

15. A manufacturing device for making a wire embedded strap, comprising:
means for continuously moving a poly sheet along a machine direction;
means for heating a conductive strip continuously moving toward the poly sheet;
means for embedding the heated conductive strip into the poly sheet as the conductive strip and poly sheet continuously move to form an embedded conductive strip;
means for separating the embedded conductive strip along the machine direction into portions of the conductive strip; and
means for forming nonconductive gaps between consecutive portions of the conductive strip, the consecutive portions conductively communicatable with a respective circuit bridging the nonconductive gap.

16. The manufacturing device of claim 15, further comprising means for aligning the heated conductive gap with the poly sheet before embedding the heated conductive strip into the poly sheet.

17. The manufacturing device of claim 15, further comprising means for placing respective circuits over the nonconductive gaps, and means for bonding the respective circuits to the consecutive portions adjacent the nonconductive gaps.

18. The manufacturing device of claim 15, wherein said means for separating the conductive strip includes means for periodically ablating the conductive strip embedded in the poly sheet continuously moving along the machine direction to form the nonconductive gaps.

19. The manufacturing device of claim 15, wherein said means for separating the conductive strip includes means for gripping the embedded conductive strip that is continuously moving along the machine direction at a first speed, and means for periodically urging the portions of the embedded conductive strip continuously moving along the machine direction at a second speed greater than the first speed to form the nonconductive gap.

20. The manufacturing device of claim 15, wherein said means for embedding the heated conductive strip into the poly sheet includes means for periodically pushing the heated conductive strip into the poly sheet to periodically embed the conductive strip, and the means for separating the embedded conductive strip includes means for cutting the conductive strip that is not embedded in the poly sheet to form the portions of the conductive strip, the cutting of the conductive strip also forming the nonconductive gaps.

21. A method for making a wire embedded strap, comprising:
continuously moving a poly sheet along a machine direction;
heating a conductive strip continuously moving toward the poly sheet;
embedding the heated conductive strip into the poly sheet as the conductive strip and poly sheet continuously move to form an embedded conductive strip;
separating the embedded conductive strip along the machine direction into portions of the conductive strip; and
forming nonconductive gaps between consecutive portions of the conductive strip, the consecutive portions conductively communicatable with a respective circuit bridging the nonconductive gap.

22. The method of claim 21, further comprising aligning the heated conductive strip with the poly sheet before embedding the heated conductive strip into the poly sheet.

23. The method of claim 21, further comprising placing respective circuits over the nonconductive gaps, and bonding the respective circuits to the consecutive portions adjacent the nonconductive gaps.

24. The method of claim 21, wherein the step of separating the conductive strip includes periodically ablating the conductive strip embedded in the poly sheet continuously moving along the machine direction to form the nonconductive gaps.

25. The method of claim 21, wherein the step of separating the conductive strip includes gripping the embedded conductive strip that is continuously moving along the machine direction at a first speed, and periodically urging the portions of the embedded conductive strip continuously moving along the machine direction at a second speed greater than the first speed to form the nonconductive gap.

26. The method of claim 21, wherein the step of embedding the heated conductive strip into the poly sheet includes periodically pushing the heated conductive strip into the poly sheet to periodically embed the conductive strip, and the step of separating the embedded conductive strip includes cutting the conductive strip that is not embedded in the poly sheet to form the portions of the conductive strip, the cutting of the conductive strip also forming the nonconductive gaps.

27. A wire embedded strap, comprising:
a poly sheet adapted to continuously move along a machine direction of a rotary manufacturing device; and
a pair of conductive wires embedded in said poly sheet substantially in parallel along the machine direction, each of said pair of conductive wires separated along the machine direction into portions of said pair of conductive wires, consecutive portions of said pair of conductive wires distanced along the machine direction by a nonconductive gap and conductively communicatable with a respective circuit bridging said nonconductive gap.

28. The wire embedded strap of claim 27, further comprising said respective circuit conductively coupled to respective consecutive portions of said pair of conductive wires and conductively bridging said nonconductive gap between said respective consecutive portions.
